(19) United States
(12) Patent Application Publication
(10) Pub. No.: US 2026/0031978 A1
(43) Pub. Date: Jan. 29, 2026

(54) PAILLIER CRYPTOSYSTEM WITH IMPROVED PERFORMANCE

(71) Applicant: Intel Corporation, Santa Clara, CA (US)

(72) Inventors: Bin Wang, Beijing (CN); Bo Peng, Beijing (CN)

(73) Assignee: Intel Corporation, Santa Clara, CA (US)

(21) Appl. No.: 18/993,985

(22) PCT Filed: Aug. 15, 2022
(86) PCT No.: PCT/CN2022/112396

§ 371 Date: Jan. 13, 2025

(51) Int. Cl. H04L 9/08

(52) U.S. Cl. CPC H04L 9/0825

(57) ABSTRACT

An improved Paillier cryptosystem generates a product of ciphertext data and plaintext data by inverting ciphertext data using a square of a public encryption key to generate a modular multiplicative inverse of the ciphertext data; subtracting plaintext data from the public encryption key to generate negative plaintext data; and generating a modular exponentiation of the modular multiplicative inverse of the ciphertext data, the negative plaintext data and the square of the public encryption key.

### CLAIM OF PRIORITY

This application claims, under 35 U.S.C. § 371, the benefit of and priority to International Application No. PCT/CN2022/112396, filed Aug. 15, 2022, titled PAILLIER CRYPTOSYSTEM WITH IMPROVED PERFORMANCE, the entire content of which is incorporated herein by reference.

### FIELD OF THE DISCLOSURE

This disclosure relates generally to security in computing systems, and more particularly, to improving performance of Paillier cryptosystems in computing systems.

### BACKGROUND

The Paillier cryptosystem was described by Pascal Paillier in “Public-Key Cryptosystems Based on Composite Degree Residuosity Classes”, EUROCRYPT'99, Lecture Notes in Computer Science (LNCS) 1592, pp. 223-238, 1999. The Paillier cryptosystem is a partial homomorphic encryption (HE) scheme, and since HE has extremely high security, the Paillier cryptosystem has been widely used in cloud computing and data aggregation scenarios. For example, many federated artificial intelligence (AI) frameworks use a Paillier cryptosystem to collaborate on data while protecting data security and privacy. As the Paillier cryptosystem must use highly complex mathematical computations that consume energy and processing resources, including modular exponentiation operations, the Paillier cryptosystem has become a performance bottleneck in AI frameworks and other data processing.

### BRIEF DESCRIPTION OF THE DRAWINGS

FIG. 1 illustrates a computing system having an improved Paillier cryptosystem according to an example.

FIG. 2 is a flow diagram of improved ciphertext data multiplied by plaintext data processing in one example.

FIG. 3 is a diagram of 1,024 bits of memory storing a random number n (e.g., a public encryption key) minus a prime number according to an example.

FIG. 4A is a chart of processing time of ciphertext data multiplied by plaintext data according to an example.

FIG. 4B is a chart of a speedup of processing time of ciphertext data multiplied by plaintext data according to an example.

FIG. 5 is a diagram of a window-based lookup table (LUT) approach to performing encryption of plaintext data according to an example.

FIG. 6 is a chart comparing a performance ratio of an AVX512-IFMA implementation with a window-based lookup table implementation for different window sizes according to an example.

FIG. 7 is a chart associating memory needed for a window-based lookup table implementation with different window sizes according to an example.

FIG. 8 is a block diagram of an example processor platform structured to execute and/or instantiate the machine-readable instructions and/or operations of FIGS. 1-7 to implement the apparatus discussed with reference to FIGS. 1-7.

FIG. 9 is a block diagram of an example implementation of the processor circuitry of FIG. 8.

FIG. 10 is a block diagram of another example implementation of the processor circuitry of FIG. 8.

FIG. 11 is a block diagram illustrating an example software distribution platform to distribute software such as the example machine readable instructions of FIG. 8 to hardware devices owned and/or operated by third parties.

The figures are not to scale. In general, the same reference numbers will be used throughout the drawing(s) and accompanying written description to refer to the same or like parts.

### DETAILED DESCRIPTION

The technology described herein provides a method, system and apparatus to improve performance of Paillier cryptosystem processing in a computing system. A first performance improvement described herein replaces an original method described by Paillier with an equivalent method that, when implemented, uses less computing resources to obtain faster performance for computing ciphertext data (CT) multiplied by plaintext data (PT), when the plaintext data length is large. As used herein, a large plaintext data size is 1,024 bits or greater, in one example. A second performance improvement described herein used a mixed window-based lookup table (LUT) and known 512-bit extensions to 256-bit advanced vector extensions (AVX) integer fused multiply accumulate (IFMA) (AVX512-IFMA) instructions to speed up a noise portion of ciphertext data computation.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and/or other changes may be made without departing from the scope of the subject matter of this disclosure. The following detailed description is, therefore, provided to describe example implementations and not to be taken as limiting on the scope of the subject matter described in this disclosure. Certain features from different aspects of the following description may be combined to form yet new aspects of the subject matter discussed below.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real-world imperfections.

As used herein, “processor” or “processing device” or “processor circuitry” or “hardware resources” are defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s). As used herein, a device may comprise processor circuitry or hardware resources.

As used herein, a computing system can be, for example, a server, a personal computer, a workstation, a self-learning machine (e.g., a neural network), a mobile device (e.g., a cell phone, a smart phone, a tablet (such as an iPad™)), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, an electronic voting machine, or any other type of computing device.

The performance improvements of the technology described herein focus on the performance of modular exponentiation operations, which is a performance bottleneck of the Paillier cryptosystem. To improve performance of the Paillier cryptosystem, the present technology replaces processing of the original method described by Paillier to compute the ciphertext data multiplied by the plaintext data with equivalent processing to obtain faster performance when the plaintext data bit length is large, and uses a mixed lookup table and AVX512-IFMA instructions to speed up modular exponentiation calculations for encryption of plaintext data, which improves performance of the existing bottleneck of noise calculation.

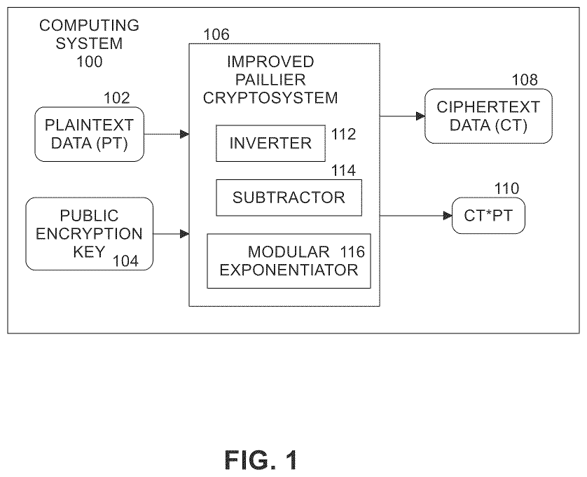

FIG. 1 illustrates a computing system 100 having an improved Paillier cryptosystem 106 according to an example. Improved Paillier cryptosystem 106 is executed by computing system 100 to take plaintext data 102 and public encryption key 104 as inputs and generate ciphertext data 108. In an embodiment, plaintext data 102 comprises a plurality of bits stored in a register of a processor of computing system 100 or a memory location of computing system 100. In an embodiment, ciphertext data 108 comprises a plurality of bits stored in a register of a processor of computing system 100 or a memory location of computing system 100. In an embodiment, the number of bits in plaintext data 102 is 1,024 and the number of bits in ciphertext data 108 is 1,024. In one implementation, improved Paillier cryptosystem 106 comprises a cryptographic software library that includes functions to be called by other software (e.g., applications software, operating system (OS) software, etc.) being executed by computing system 100 to perform encryption of plaintext data (PT) 102 to produce ciphertext data (CT) 108 and multiplication of ciphertext data and plaintext data (CT*PT) as described herein. In another implementation, improved Paillier cryptosystem 106 comprises circuitry within a processor to perform encryption of plaintext data 102 and multiplication of ciphertext data 108 and plaintext data 102 as described herein. In either implementation (either software comprising instructions for execution by a processor or computer hardware circuitry), improved Paillier cryptosystem 106 includes inverter 112 (either software comprising instructions for execution by a processor or computer hardware circuitry) to invert ciphertext data 108 using a square of public encryption key 104 to generate a modular multiplicative inverse of ciphertext data 108, subtractor 114 (either software comprising instructions for execution by a processor or computer hardware circuitry) to subtract plaintext data 102 from public encryption key 104 to generate negative plaintext data, and modular exponentiator 116 (either software comprising instructions for execution by a processor or computer hardware circuitry) to generate a modular exponentiation of the modular multiplicative inverse of ciphertext data 108, the negative plaintext data, and the square of the public encryption key. The result of modular exponentiator 116 is the product of ciphertext data (CT) 108 and plaintext data (PT) 102 (CT*PT 110). The result may be used by applications (for example, machine learning applications) to be executed by computing system 100. Since the performance of the processing to determine CT*PT 110 is improved by improved Paillier cryptosystem 106, performance of applications of computing system 100 using CT*PT 110 are also improved.

Each of inverter 112, subtractor 114, and modular exponentiator 116 may be implemented in one of software comprising instructions for execution by a processor or computer hardware circuitry (e.g., in a processor or in dedicated circuitry in computing system 100 for improved Paillier cryptosystem 106) in any combination, depending on the implementation.

In the Paillier cryptosystem, the following parameters are used: first prime number p, second prime number q, product of prime numbers n=pq, lambda λ=least common multiple (p−1; q−1); selected random integer g where g∈zₙ_{²} (g belongs to the range 0 to n²) and the order of g is a multiple of n.

To perform encryption:
plaintext message m such that 0<m<n
select a random r such that 0<r<n

$$ciphertext c = {g}^{m} {r}^{n} mod {n}^{2} \qquad Equation ( 1 )$$

To perform decryption:
ciphertext c∈zₙ_{²}

$$plaintext m = \frac{L ( {c}^{λ} mod {n}^{2} )}{L ( {g}^{λ} mod {n}^{2} )} mod n$$

By examination of Equation (1), a bottleneck of ciphertext computing can be split into two modular exponentiation computing operations: 1) the plaintext computation (PC) of g^{m} mod n²; and 2) the noise computation (NC) of rⁿmod n². The technology described below improves performance of these two modular exponentiation computing operations.

The Paillier cryptosystem is an encryption scheme that allows linear computation on encrypted data, such that performing operations (e.g., addition and multiply) on encrypted data and decrypting the result is equivalent to performance analogous operations without any encryption.

The first improvement described herein is designed to improve performance of the PC phase for the operation of multiplying the ciphertext data times the plaintext data. This operation is widely used in machine learning applications. Improving performance of multiplying the ciphertext data by the plaintext data results in substantial improvement of the machine learning applications. In one example, the technology described herein resulted in an approximately 6.3× speedup for performing multiplying the ciphertext data by the plaintext data as compared to the original Paillier cryptosystem.

In Equation (1), in one implementation, improved Paillier cryptosystem 106 sets g=n+1, which results in time savings since:

$${( n + 1 )}^{m} mod {n}^{2} = ( n * m + 1 ) mod {n}^{2} \qquad Equation ( 2 )$$

From Equation (2), a modular exponentiation is converted to a modular multiplication, so performance of the encryption operation in the original Paillier cryptosystem gets benefits through Equation (2), but a drawback still exists in the Paillier cryptosystem: Equation (2) can only be applied for the encryption of plaintext data; however, for the operation of ciphertext data multiplied by plaintext data, a modular exponentiation still needs to be calculated:

$$e ( p 1 ) * p 2 = {( e ( p 1 ) )}^{p 2} mod {n}^{2} \qquad Equation ( 3 )$$

In Equation (3), e(p1) represents ciphertext of plaintext p1, and p2 is plaintext data. The cost of modular exponentiation needs to be reduced for the operation of ciphertext data multiplied by plaintext data when the plaintext data is large in Equation (3). To achieve this goal, in an embodiment the definition of modular multiplicative inverse is used. Thus, a modular multiplicative inverse of an integer a is an integer x such that a*x is congruent to 1 modular some modulus a. This can be written in a formal way for the improved Paillier cryptosystem 106 (where ≡ is the same modulo result):

$$a * x ≡ 1 mod {n}^{2} \qquad Equation ( 4 )$$

From Equation (4), x=a⁻¹, then Equation (3) can be calculated as:

$${( e ( p 1 ) )}^{p 2} mod {n}^{2} = {( e {( p 1 )}^{- 1} )}^{n - p 2} mod {n}^{2} \qquad Equation ( 5 )$$

where n is the public encryption key 104.

Example pseudocode to perform the proposed operation of ciphertext data multiplied by plaintext data is shown in Table 1. As used herein, the function powmod (h, i, j, k) computes hⁱ mod j where h and k are polynomials in k, and i is an integer, possibly negative.

TABLE 1
© 2022 Intel Corporation
If public_key.n − plaintext < threshold
#large plaintext processing with modular multiplicative inverse
InverseCiphertext = invert(ciphertext, public_key.nsquare)
negPlaintext = public_key.n − plaintext
Return powmod(InverseCiphertext, negPlaintext, public_key.nsquare)
Else
Return powmod(ciphertext, plaintext, public_key.nsquare)

When p2 is large plaintext data, an invert function is applied to calculate the modular multiplicative inverse, then a negative plaintext is defined as negPlaintext=n−p2, then n−p2 will get a smaller plaintext data compared with original plaintext data p2, and finally the powmod function is called for modular exponentiation calculation. From these three steps, a modular exponentiation calculation is exchanged for an invert, a subtraction, and a modular exponentiation with smaller powers, thereby improving performance.

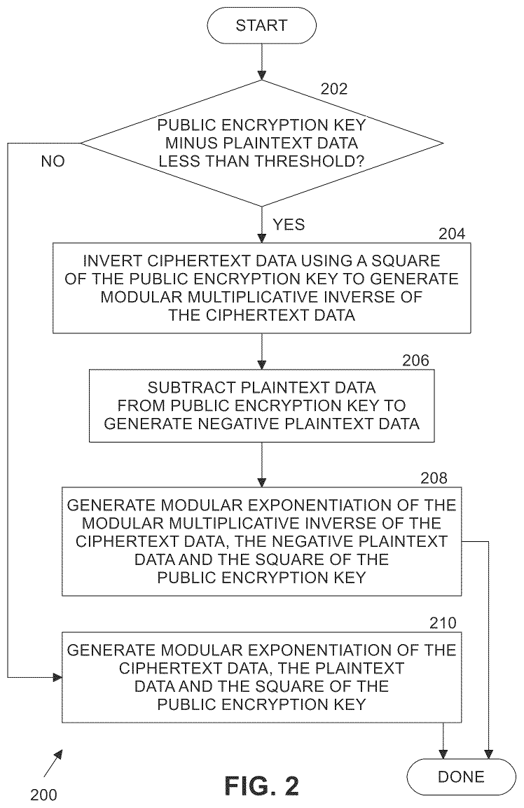

FIG. 2 is a flow diagram of improved ciphertext data multiplied by plaintext data processing 200 in one example. At block 202, improved Paillier cryptosystem 106 determines if the public encryption key n minus the plaintext data p2 is less than a threshold. If so, at block 204, improved Paillier cryptosystem 106 inverts the ciphertext data (e.g., e(p1)) using a square of the public encryption key (e.g., n²) to generate a modular multiplicative inverse of the ciphertext data (e.g., InverseCiphertext). At block 206, improved Paillier cryptosystem 106 subtracts the plaintext data (e.g., p2) from the public encryption key (e.g., n) to generate negative plaintext data (e.g., n−p2). At block 208, improved Paillier cryptosystem 106 generates a modular exponentiation of the modular multiplicative inverse of the ciphertext data, the negative plaintext and the square of the public encryption key. The result of performing block 208 is returned as the product of the ciphertext data and the plaintext data (e.g., CT*PT). If the public encryption key n minus the plaintext data p2 is not less than the threshold at block 202, at block 210 improved Paillier cryptosystem 106 generates a modular exponentiation of the ciphertext data, the plaintext data (e.g., p2) and the square of the public encryption key (e.g., n²). The result of performing block 210 is returned as the product of the ciphertext data and the plaintext data (e.g., CT*PT).

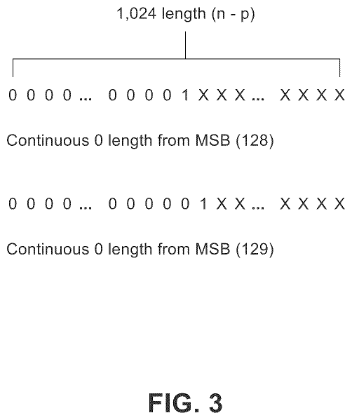

An issue is how to determine the threshold. During testing, it was found that the speed up of Equation (5) depends on zeros in high bits in the negative plaintext data n−p2. FIG. 3 is a diagram of 1,024 bits of memory storing a random number n (e.g., a public encryption key) minus a prime number p2 according to an example. FIG. 3 shows two examples of continuous 0 length from the most significant bit (MSB) in n−p2. With a bit length len(n)=1024 as an example, the threshold may be set as threshold=n&(1<<(len(n)−128)−1)(=128 in this example). Hence, the threshold depends on the bit length of n.

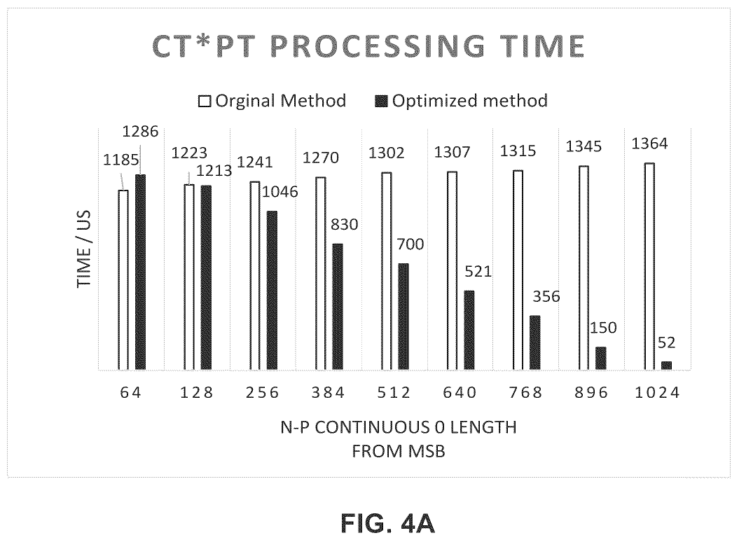

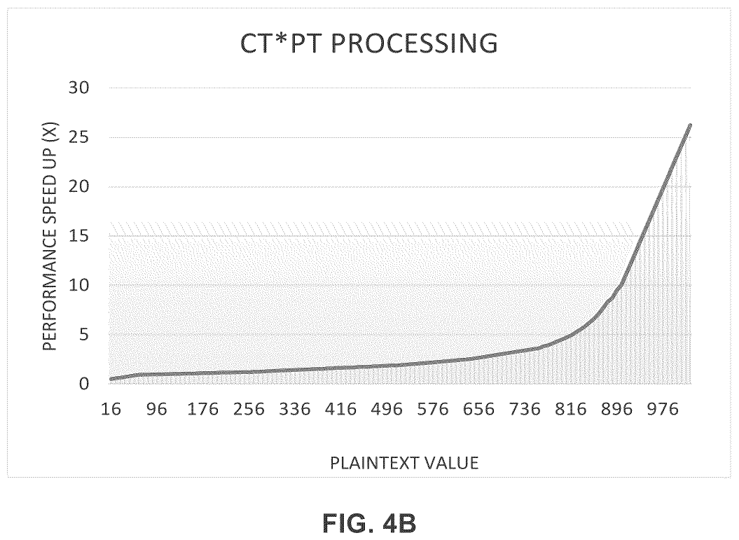

In performance tests, different continuous zero lengths from MSB in n−p2 and different lengths of plaintext (belonging to the definition in the Paillier cryptosystem (e.g., plaintext 0<m<n)) are modeled. FIG. 4A is a chart of processing time of multiplying ciphertext by plaintext (CT*PT) according to an example. FIG. 4A shows the improvement of the optimized method of improved Paillier cryptosystem 106 described herein for multiplying ciphertext data by plaintext data as compared to the original method described by Paillier. FIG. 4B is a chart of the processing speedup of multiplying ciphertext data by plaintext data according to an example. As FIGS. 4A and 4B show, a larger performance improvement is gained as the length of the plaintext data 102 is closer to the length of public encryption key n and the maximum speedup can reach to more than approximately 25×.

In one implementation, AVX512-IFMA instructions for this improved modular exponentiation calculation of ciphertext data multiplied by plaintext data may also be used for further performance improvement.

The second improvement described herein is designed to improve performance of the noise computation (NC) of rⁿmod n². In this second improvement, a window-based lookup table (LUT) and/or AVX512-IFMA instructions are applied for improvement of performance of modular exponentiation operations.

In “A Generalization of Paillier's Public-Key System with Applications to Electronic Voting” by Ivan Damgard, Mads Jurik, and Jesper Buus Nielsen, International Journal of Information Security 9, pp. 371-385, Sep. 30, 2010, the authors describe a method to optimize noise computation, that is, replace rⁿmod n² with:

$$c = {g}^{m} {h}_{s}^{a} mod {n}^{s + 1} \qquad Equation ( 6 )$$

where s=1, and random a∈ [symbol] and h is a fixed base number.

From the range of random value a it is known that the bit size is half compared with the original Paillier cryptosystem, and hₛ can be precomputed in a key generation function, then this can be treated as a fixed base modular exponentiation optimization problem. In an embodiment, a is a very large random integer having 1,024 bits.

$$noise = {h}_{s}^{a} mod {n}^{2} \qquad Equation ( 7 )$$

To accelerate Equation (7), in one embodiment, AVX512-IFMA instructions available on processors from Intel Corporation may be applied to optimize this modular exponentiation computation. This results in an approximately 6× speedup compared with a previous implementation without using AVX512-IFMA instructions.

To further optimize the fixed base modular exponentiation computation, in another embodiment, a window based look up table may be applied for even better performance as described below.

First, the random a⊂ [symbol] is extracted to a plurality of binary additions for the computation:

$$a = {\sum }_{k} {b}_{i} \qquad Equation ( 8 )$$

Where k is the bit-length of a, and bᵢis the binary representation at different bit positions. For example, if the length of a is 1,204 bits, then the range of a would be 0000000 . . . 00000 to 1111111 . . . 111111. For example, if the bit length of a is 4, then the range of a is 0000 to 1111, and a=15 can be represented by:

$$a = 0001 + 00 \; 10 + 0100 + 1000$$

Assume the bit-length of a is 4, substitute Equation (8) into Equation (7):

$$noise = {h}_{s}^{{\sum }_{k} {b}_{i}} mod {n}^{2} = {h}_{s}^{( 1000 + 0100 + 0010 + 0001 )} mod {n}^{2}$$

Based on the assume theorem:

$$a * b mod n = ( a mod n * b mod n ) mod n$$

The noise can be calculated by equation:

$$noise = {\prod }_{k} {h}_{s}^{{b}_{i}} mod {n}^{2} \qquad Equation ( 9 )$$

From this equation (9) a fixed base modular exponentiation can be replaced with [symbol] times modular multiplication, which can be pre-computed (e.g., at compile time) and saved in the lookup table because hₛ and bᵢ are fixed once the public key (e.g., public encryption key 104 n) is obtained by a key generation function. No matter what the runtime value of a is, improved Paillier cryptosystem 106 only needs to access the lookup table and perform a plurality of multiplication operations to generate results.

For the simple example where the bit length of a is 4:

$$If a = 0101 , pow ( {h}_{s} , a ) = pow ( {h}_{s} , 0100 ) * pow ( {h}_{s} , 0001 )$$

$$If a = 0111 , pow ( {h}_{s} , a ) = pow ( {h}_{s} , 0100 ) * pow ( {h}_{s} , 0010 ) * pow ( {h}_{s} , 0001 )$$

$$If a = 1101 , pow ( {h}_{s} , a ) = pow ( {h}_{s} , 1000 ) * pow ( {h}_{s} , 0100 ) * pow ( {h}_{s} , 0001 )$$

$$If a = 1111 , pow ( {h}_{s} , a ) = pow ( {h}_{s} , 1000 ) * pow ( {h}_{s} , 0010 ) * pow ( {h}_{s} , 0010 ) * pow ( {h}_{s} , 0001 )$$

Thus, the pow () calculation becomes unnecessary, being replaced by one to four lookup table operations. For example, when a=13=1101, three table lookups and two multiplications may be used to get the equivalent pow () function's results.

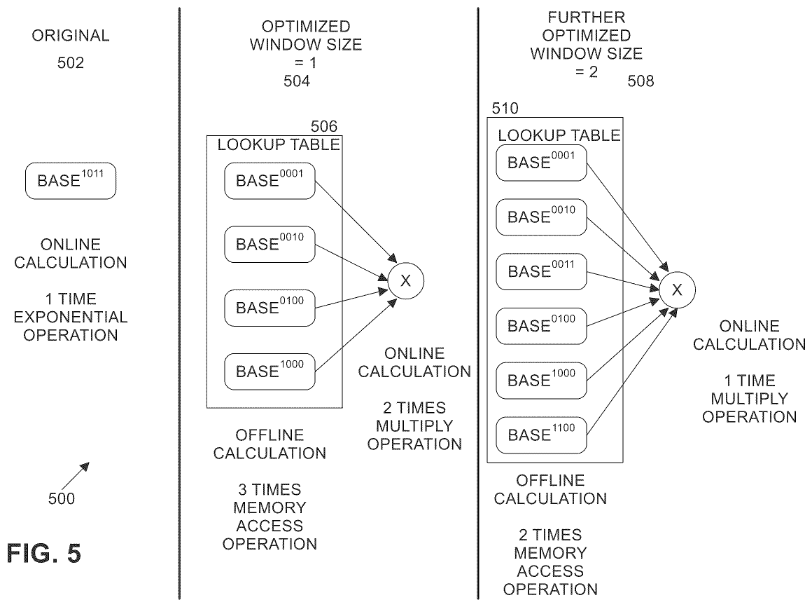

Second, according to test results, [symbol] times modular multiplication is still time consuming and slower than the AVX512-IFMA implementation. To further improve the lookup table method, a window based look up table 506, 510 may be applied. FIG. 5 is a diagram of a window-based lookup table approach according to an example. Multiple bᵢs may be combined as a window and the random a is extracted based on the window size w. From this optimization, a modular exponentiation is converted to

$$\frac{n}{2 w}$$

modular multiplications. For example, in FIG. 5 three modular multiplications are changed when window size w=1 504 for window-based lookup table 506, and two modular multiplications are changed when window size w=2 508 for window-based lookup table 510, as compared to original method 502.

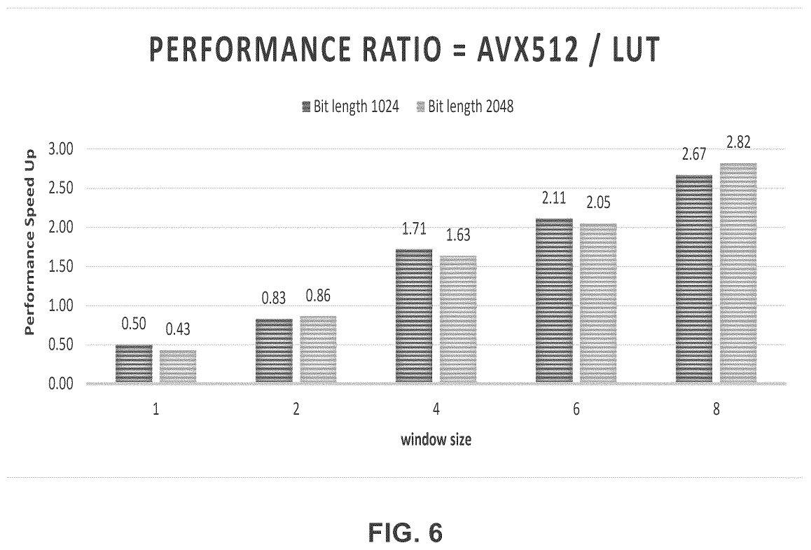

It is apparent that more time will be saved as the window size w increases, but the memory usage will also increase substantially. In performance tests, it has been found that when the window size w is set to 4, the performance of the window-based lookup table method will be slightly faster than an AVX512-IFMA instructions implementation. By increasing the window size w to 8, the window-based lookup table method achieves an approximately 3× speedup compared with the AVX512-IFMA instructions implementation, as shown in FIG. 6. The window-based lookup table performs better than AVX512-IFMA instructions in this example when the bit length is 1,204 and 2,048.

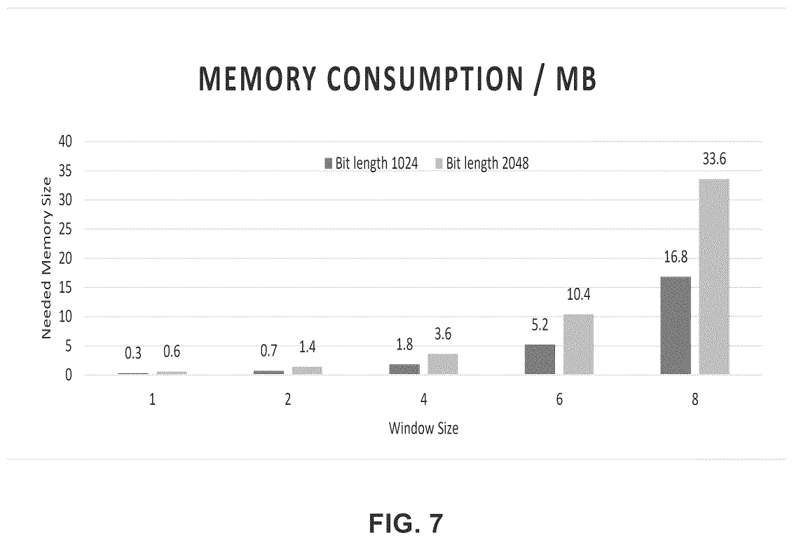

One drawback is that with a bigger window size, more memory resources are needed. FIG. 7 is a chart associating memory needed for a window-based lookup table implementation with different window sizes according to an example. From FIG. 7 it can be observed that when the window size is increased to 8, the memory consumption will increase to 33 MB.

To balance the performance improvement and memory consumption, in an embodiment a combined window-based lookup table 510 and Intel's AVX512-IFMA instructions are applied to speed up modular exponentiation, wherein the window-based lookup table is pre-computed (at compile time) for the high bits of the exponentiation and at runtime the low bit modular exponentiation is calculated with AVX512-IFMA instructions. For example, assuming a bit length of random a is 1024, then the lookup table 510 may be pre-computed for a's high 512 bits and at runtime the low 512-bits modular exponentiation is calculated with AVX512-IFMA instructions, from this half the memory cost can be saved but as little performance as possible is lost. In this framework, the high and low bit sizes can be chosen by a user to balance the performance and memory usage. In one implementation, the high bit is set to 256, and the low bit is set to 768.

By implementing both improvements, the improved Paillier cryptosystem's performance is improved by approximately 12.4× for encryption operations over the original Paillier cryptosystem according to some experiments.

While an example manner of implementing the technology described herein is illustrated in FIGS. 1-7, one or more of the elements, processes, and/or devices illustrated in FIGS. 1-7 may be combined, divided, re-arranged, omitted, eliminated, and/or implemented in any other way. Further, the example improved Paillier cryptosystem 106 may be implemented by hardware, software, firmware, and/or any combination of hardware, software, and/or firmware. Thus, for example, any portion or all of the improved Paillier cryptosystem could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example hardware resources is/are hereby expressly defined to include a non-transitory computer readable storage device or storage disk such as a memory, a digital versatile disk (DVD), a compact disk (CD), a Blu-ray disk, etc., including the software and/or firmware. Further still, the example embodiments of FIGS. 1-7 may include one or more elements, processes, and/or devices in addition to, or instead of, those illustrated in FIGS. 1-7, and/or may include more than one of any or all the illustrated elements, processes and devices.

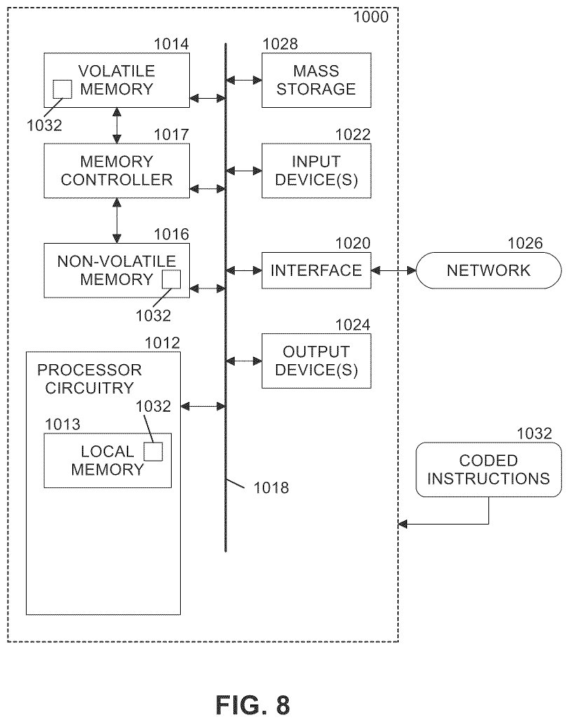

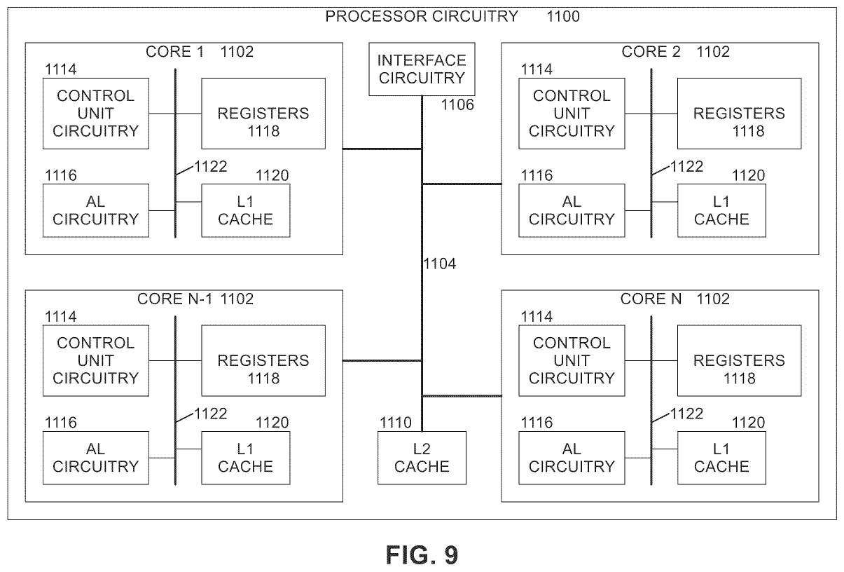

A flowchart representative of example hardware logic circuitry, machine readable instructions, hardware implemented state machines, and/or any combination thereof is shown in FIG. 2. The machine readable instructions may be one or more executable programs or portion(s) of an executable program for execution by processor circuitry, such as the processor circuitry 1012 shown in the example processor platform 1000 discussed below in connection with FIG. 8 and/or the example processor circuitry discussed below in connection with FIGS. 9 and/or 10. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The tangible machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 2, many other methods of implementing the example computing system may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable media, as used herein, may include machine readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 2 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a block diagram of an example processor platform 1000 structured to execute and/or instantiate the machine-readable instructions and/or operations of FIGS. 1-2. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements the example processor circuitry 122.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1032, which may be implemented by the machine-readable instructions of FIGS. 1-2, may be stored in the mass storage device 1028, in the volatile memory 1014, in the non-volatile memory 1016, and/or on a removable non-transitory computer readable storage medium such as a CD or DVD.

FIG. 9 is a block diagram of an example implementation of the processor circuitry 1012 of FIG. 8. In this example, the processor circuitry 1012 of FIG. 9 is implemented by a microprocessor 1100. For example, the microprocessor 1100 may implement multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all the machine-readable instructions and/or operations represented by the flowchart of FIGS. 2.

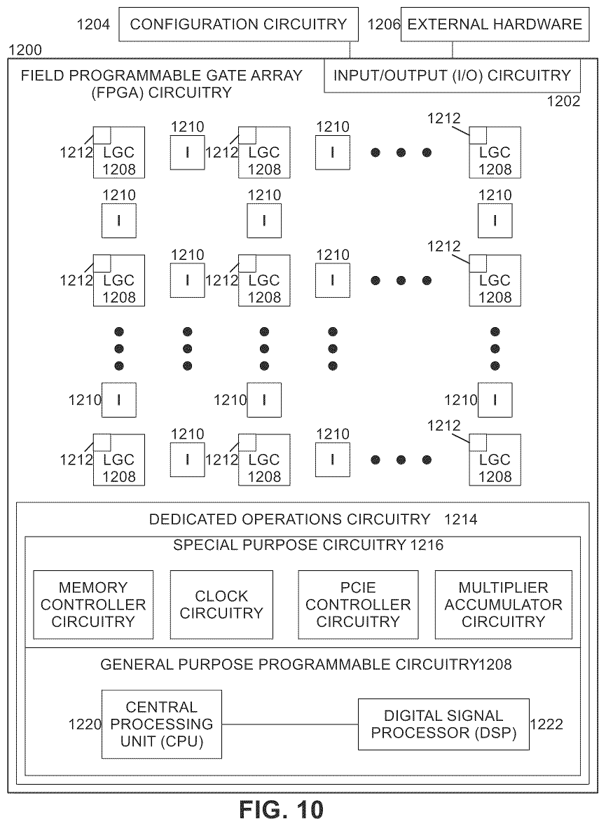

The cores 1102 may communicate by an example bus 1104. In some examples, the bus 1104 may implement a communication bus to effectuate communication associated with one(s) of the cores 1102. For example, the bus 1104 may implement at least one of an Inter-Integrated Circuit (I2C) bus, a Serial Peripheral Interface (SPI) bus, a PCI bus, or a PCIe bus. Additionally or alternatively, the bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2_ cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the L1 cache in local memory 1120, and an example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating point operations. In yet other examples, the AL circuitry 1116 may include first AL circuitry that performs integer-based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 9. Alternatively, the registers 1118 may be organized in any other arrangement, format, or structure including distributed throughout the core 1102 to shorten access time. The bus 1104 may implement at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general-purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 10 is a block diagram of another example implementation of the processor circuitry 1012 of FIG. 8. In this example, the processor circuitry 1012 is implemented by FPGA circuitry 1200. The FPGA circuitry 1200 can be used, for example, to perform operations that could otherwise be performed by the example microprocessor 1100 of FIG. 9 executing corresponding machine-readable instructions. However, once configured, the FPGA circuitry 1200 instantiates the machine-readable instructions in hardware and, thus, can often execute the operations faster than they could be performed by a general-purpose microprocessor executing the corresponding software.

More specifically, in contrast to the microprocessor 1100 of FIG. 9 described above (which is a general purpose device that may be programmed to execute some or all of the machine readable instructions represented by the flowchart of FIG. 2 but whose interconnections and logic circuitry are fixed once fabricated), the FPGA circuitry 1200 of the example of FIG. 10 includes interconnections and logic circuitry that may be configured and/or interconnected in different ways after fabrication to instantiate, for example, some or all of the machine readable instructions represented by the flowchart of FIG. 2. In particular, the FPGA 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowchart of FIG. 2. As such, the FPGA circuitry 1200 may be structured to effectively instantiate some or all the machine-readable instructions of the flowchart of FIG. 2 as dedicated logic circuits to perform the operations corresponding to those software instructions in a dedicated manner analogous to an ASIC. Therefore, the FPGA circuitry 1200 may perform the operations corresponding to the some or all the machine-readable instructions of FIG. 2 faster than the general-purpose microprocessor can execute the same.

In the example of FIG. 10, the FPGA circuitry 1200 is structured to be programmed (and/or reprogrammed one or more times) by an end user by a hardware description language (HDL) such as Verilog. The FPGA circuitry 1200 of FIG. 10, includes example input/output (I/O) circuitry 1202 to obtain and/or output data to/from example configuration circuitry 1204 and/or external hardware (e.g., external hardware circuitry) 1206. For example, the configuration circuitry 1204 may implement interface circuitry that may obtain machine readable instructions to configure the FPGA circuitry 1200, or portion(s) thereof. In some such examples, the configuration circuitry 1204 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may implement the microprocessor 1100 of FIG. 9. The FPGA circuitry 1200 also includes an array of example logic gate circuitry 1208, a plurality of example configurable interconnections 1210, and example storage circuitry 1212. The logic gate circuitry 1208 and interconnections 1210 are configurable to instantiate one or more operations that may correspond to at least some of the machine-readable instructions of FIG. 2 and/or other desired operations. The logic gate circuitry 1208 shown in FIG. 10 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 10 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 9 and 10 illustrate two example implementations of the processor circuitry 1012 of FIG. 8, many other approaches are contemplated. For example, as mentioned above, modern FPGA circuitry may include an on-board CPU, such as one or more of the example CPU 1220 of FIG. 5. Therefore, the processor circuitry 1012 of FIG. 8 may additionally be implemented by combining the example microprocessor 1100 of FIG. 9 and the example FPGA circuitry 1200 of FIG. 10. In some such hybrid examples, a first portion of the machine-readable instructions represented by the flowchart of FIG. 2 may be executed by one or more of the cores 1102 of FIG. 9 and a second portion of the machine-readable instructions represented by the flowchart of FIG. 2 may be executed by the FPGA circuitry 1200 of FIG. 10.

In some examples, the processor circuitry 1012 of FIG. 8 may be in one or more packages. For example, the microprocessor 1100 of FIG. 9 and/or the FPGA circuitry 1200 of FIG. 10 may be in one or more packages. In some examples, an XPU may be implemented by the processor circuitry 1012 of FIG. 8, which may be in one or more packages. For example, the XPU may include a CPU in one package, a DSP in another package, a GPU in yet another package, and an FPGA in still yet another package.

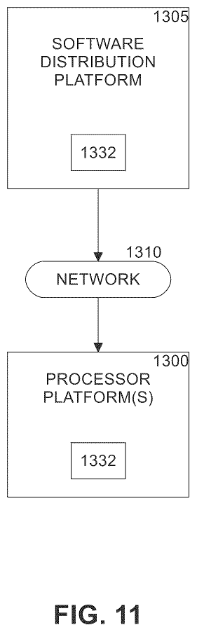

A block diagram illustrating an example software distribution platform 1305 to distribute software such as the example machine readable instructions 1032 of FIG. 8 to hardware devices owned and/or operated by third parties is illustrated in FIG. 11. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 8. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1032, which may correspond to the example machine readable instructions, as described above. The one or more servers of the example software distribution platform 1305 are in communication with a network 1310, which may correspond to any one or more of the Internet and/or any of the example networks, etc., described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1032 from the software distribution platform 1305. For example, the software, which may correspond to the example machine readable instructions described above, may be downloaded to the example processor platform 1300, which is to execute the machine-readable instructions 1032 to implement the methods described above and associated computing system 100. In some examples, one or more servers of the software distribution platform 1305 periodically offer, transmit, and/or force updates to the software (e.g., the example machine readable instructions 1032 of FIG. 8) to ensure improvements, patches, updates, etc., are distributed and applied to the software at the end user devices.

In some examples, an apparatus includes means for data processing of FIGS. 1-2. For example, the means for processing may be implemented by processor circuitry, processor circuitry, firmware circuitry, etc. In some examples, the processor circuitry may be implemented by machine executable instructions executed by processor circuitry, which may be implemented by the example processor circuitry 1012 of FIG. 8, the example microprocessor 1100 of FIG. 9, and/or the example Field Programmable Gate Array (FPGA) circuitry 1200 of FIG. 10. In other examples, the processor circuitry is implemented by other hardware logic circuitry, hardware implemented state machines, and/or any other combination of hardware, software, and/or firmware. For example, the processor circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

From the foregoing, it will be appreciated that example systems, methods, apparatus, and articles of manufacture have been disclosed that provide improved performance for security in a computing system. The disclosed systems, methods, apparatus, and articles of manufacture improve the performance of implementing a Paillier cryptosystem in a computing system. The disclosed systems, methods, apparatus, and articles of manufacture are accordingly directed to one or more improvement(s) in the operation of a machine such as a computer or other electronic and/or mechanical device.

### Example Embodiments

The following examples pertain to further embodiments. Specifics in the examples may be used anywhere in one or more embodiments. Example 1 is an apparatus including an apparatus including an inverter to invert ciphertext data using a square of a public encryption key to generate a modular multiplicative inverse of the ciphertext data; a subtractor to subtract plaintext data from the public encryption key to generate negative plaintext data; and a modular exponentiator to generate a modular exponentiation of the modular multiplicative inverse of the ciphertext data, the negative plaintext data and the square of the public encryption key.

In Example 2, the subject matter of Example 1 optionally includes wherein the inverter is to invert ciphertext data using the square of a public encryption key to generate the modular multiplicative inverse of the ciphertext data; the subtractor is to subtract the plaintext data from the public encryption key to generate the negative plaintext data; and the modular exponentiator is to generate the modular exponentiation of the modular multiplicative inverse of the ciphertext data, the negative plaintext data and the square of the public encryption key when the public encryption key minus the plaintext data is less than a threshold. In Example 3, the subject matter of Example 2 optionally includes wherein the modular exponentiator is to generate a modular exponentiation of the ciphertext data, the plaintext data and the square of the public encryption key when the public encryption key minus the plaintext data is not less than the threshold. In Example 4, the subject matter of Example 1 optionally includes wherein the apparatus is to return the modular exponentiation of the modular multiplicative inverse of the ciphertext data, the negative plaintext data and the square of the public encryption key as a product of the ciphertext data and the plaintext data. In Example 5, the subject matter of Example 1 optionally includes a Paillier cryptosystem including the inverter, the subtractor, and the modular exponentiator.

Example 6 is a computing system including a memory to store instructions; and a processor coupled to the memory to execute the instructions to generate a product of ciphertext data and plaintext data by inverting the ciphertext data using a square of a public encryption key to generate a modular multiplicative inverse of the ciphertext data; subtracting the plaintext data from the public encryption key to generate negative plaintext data; and generating a modular exponentiation of the modular multiplicative inverse of the ciphertext data, the negative plaintext data and the square of the public encryption key.

In Example 7, the subject matter of Example 6 optionally includes wherein the processor is to invert the ciphertext data using the square of a public encryption key to generate the modular multiplicative inverse of the ciphertext data; subtract the plaintext data from the public encryption key to generate the negative plaintext data; and generate the modular exponentiation of the modular multiplicative inverse of the ciphertext data, the negative plaintext data and the square of the public encryption key when the public encryption key minus the plaintext data is less than a threshold. In Example 8, the subject matter of Example 7 optionally includes wherein the processor is to generate a modular exponentiation of the ciphertext data, the plaintext data and the square of the public encryption key when the public encryption key minus the plaintext data is not less than the threshold.

Example 9 is a method including inverting ciphertext data using a square of a public encryption key to generate a modular multiplicative inverse of the ciphertext data; subtracting plaintext data from the public encryption key to generate negative plaintext data; and generating a modular exponentiation of the modular multiplicative inverse of the ciphertext data, the negative plaintext data and the square of the public encryption key.

In Example 10, the subject matter of Example 9 optionally includes inverting the ciphertext data using the square of the public encryption key to generate the modular multiplicative inverse of the ciphertext data; subtracting the plaintext data from the public encryption key to generate the negative plaintext data; and generating the modular exponentiation of the modular multiplicative inverse of the ciphertext data, the negative plaintext data and the square of the public encryption key when the public encryption key minus the plaintext data is less than a threshold. In Example 11, the subject matter of Example 10 optionally includes generating a modular exponentiation of the ciphertext data, the plaintext data and the square of the public encryption key when the public encryption key minus the plaintext data is not less than the threshold. In Example 12, the subject matter of Example 9 optionally includes returning the modular exponentiation of the modular multiplicative inverse of the ciphertext data, the negative plaintext data and the square of the public encryption key as a product of the ciphertext data and the plaintext data.

Example 13 is at least one machine-readable storage medium comprising instructions which, when executed by at least one processor, cause the at least one processor to invert ciphertext data using a square of a public encryption key to generate a modular multiplicative inverse of the ciphertext data; subtract plaintext data from the public encryption key to generate negative plaintext data; and generate a modular exponentiation of the modular multiplicative inverse of the ciphertext data, the negative plaintext data and the square of the public encryption key.

In Example 14, the subject matter of Example 13 optionally includes instructions which, when executed by at least one processor, cause the at least one processor to invert the ciphertext data using the square of a public encryption key to generate the modular multiplicative inverse of the ciphertext data; subtract the plaintext data from the public encryption key to generate the negative plaintext data; and generate the modular exponentiation of the modular multiplicative inverse of the ciphertext data, the negative plaintext data and the square of the public encryption key when the public encryption key minus the plaintext data is less than a threshold. In Example 15, the subject matter of Example 14 optionally includes instructions which, when executed by at least one processor, cause the at least one processor to generate a modular exponentiation of the ciphertext data, the plaintext data and the square of the public encryption key when the public encryption key minus the plaintext data is not less than the threshold.

Example 16 is an apparatus operative to perform the method of any one of Examples 9 to 12. Example 17 is an apparatus that includes means for performing the method of any one of Examples 9 to 12. Example 18 is an apparatus that includes any combination of modules and/or units and/or logic and/or circuitry and/or means operative to perform the method of any one of Examples 9 to 12. Example 19 is an optionally non-transitory and/or tangible machine-readable medium, which optionally stores or otherwise provides instructions that if and/or when executed by a computer system or other machine are operative to cause the machine to perform the method of any one of Examples 9 to 12.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the examples of this patent.

1-15. (canceled)

16. An apparatus comprising:
processing circuitry coupled to a memory, the processing circuitry to:
invert ciphertext data using a square of a public encryption key to generate a modular multiplicative inverse of the ciphertext data;
subtract plaintext data from the public encryption key to generate negative plaintext data; and
generate a modular exponentiation of the modular multiplicative inverse of the ciphertext data, the negative plaintext data and the square of the public encryption key.

17. The apparatus of claim 16, wherein the processing circuitry is further to:
invert ciphertext data using the square of a public encryption key to generate the modular multiplicative inverse of the ciphertext data;
subtract the plaintext data from the public encryption key to generate the negative plaintext data; and
generate the modular exponentiation of the modular multiplicative inverse of the ciphertext data, the negative plaintext data and the square of the public encryption key when the public encryption key minus the plaintext data is less than a threshold.

18. The apparatus of claim 17, wherein the processing circuitry is further to generate a modular exponentiation of the ciphertext data, the plaintext data and the square of the public encryption key when the public encryption key minus the plaintext data is not less than the threshold.

19. The apparatus of claim 16, wherein the processing circuitry is further to return the modular exponentiation of the modular multiplicative inverse of the ciphertext data, the negative plaintext data and the square of the public encryption key as a product of the ciphertext data and the plaintext data.

20. The apparatus of claim 16, wherein the processing circuitry comprises one or more of application processing circuitry or graphics processing circuity.

21. A method comprising:
inverting, by a computing device, ciphertext data using a square of a public encryption key to generate a modular multiplicative inverse of the ciphertext data;
subtracting plaintext data from the public encryption key to generate negative plaintext data; and
generating a modular exponentiation of the modular multiplicative inverse of the ciphertext data, the negative plaintext data and the square of the public encryption key.

22. The method of claim 21, further comprising:
inverting the ciphertext data using the square of the public encryption key to generate the modular multiplicative inverse of the ciphertext data;
subtracting the plaintext data from the public encryption key to generate the negative plaintext data; and
generating the modular exponentiation of the modular multiplicative inverse of the ciphertext data, the negative plaintext data and the square of the public encryption key when the public encryption key minus the plaintext data is less than a threshold.

23. The method of claim 22, further comprising generating a modular exponentiation of the ciphertext data, the plaintext data and the square of the public encryption key when the public encryption key minus the plaintext data is not less than the threshold.

24. The method of claim 21, further comprising returning the modular exponentiation of the modular multiplicative inverse of the ciphertext data, the negative plaintext data and the square of the public encryption key as a product of the ciphertext data and the plaintext data.

25. The method of claim 21, wherein the computing device comprises processing circuitry having one or more of application processing circuitry or graphics processing circuitry.

26. At least one computer-readable medium having stored thereon instructions which, when executed, cause a computing device to perform operations comprising:
inverting ciphertext data using a square of a public encryption key to generate a modular multiplicative inverse of the ciphertext data;
subtracting plaintext data from the public encryption key to generate negative plaintext data; and
generating a modular exponentiation of the modular multiplicative inverse of the ciphertext data, the negative plaintext data and the square of the public encryption key.

27. The computer-readable medium of claim 26, wherein the operations further comprising:
inverting the ciphertext data using the square of a public encryption key to generate the modular multiplicative inverse of the ciphertext data;
subtracting the plaintext data from the public encryption key to generate the negative plaintext data; and
generating the modular exponentiation of the modular multiplicative inverse of the ciphertext data, the negative plaintext data and the square of the public encryption key when the public encryption key minus the plaintext data is less than a threshold.

28. The computer-readable medium of claim 27, wherein the operations further comprising generating a modular exponentiation of the ciphertext data, the plaintext data and the square of the public encryption key when the public encryption key minus the plaintext data is not less than the threshold.

29. The computer-readable medium of claim 26, wherein the operations further comprise returning the modular exponentiation of the modular multiplicative inverse of the ciphertext data, the negative plaintext data and the square of the public encryption key as a product of the ciphertext data and the plaintext data.

30. The computer-readable medium of claim 26, wherein the computing device comprises one or more processors having one or more application processors or one or more graphics processors.
